(19) United States
(12) Patent Application Publication
(10) Pub. No.: US 2025/0006158 A1
(43) Pub. Date: Jan. 2, 2025

(54) MULTIPARTY PARTICIPATORY MIDI-BASED CONTENT GENERATION SYSTEM AND METHOD

(71) Applicant: MusicBox Entertainment, Inc., Seoul (KR)

(72) Inventors: Ju Ho JUNG, Seoul (KR); Jae Ho JANG, Incheon (KR); Ki Seo KIM, Calabasas, CA (US); Jae Hyuk CHANG, Los Angeles, CA (US)

(73) Assignee: MusicBox Entertainment, Inc., Seoul (KR)

(21) Appl. No.: 18/759,988

(22) Filed: Jun. 30, 2024

(30) Foreign Application Priority Data
Jun. 29, 2023 (KR) 10-2023-0084403

(51) Int. Cl. G10H 1/00

(52) U.S. Cl. CPC G10H 1/0025; G10H 1/0066; G10H 2210/056; G10H 2210/111; G10H 2240/311

(57) ABSTRACT

Disclosed are a multiparty participatory MIDI-based content generation system and method configured such that a plurality of users communicates with a server via respective user terminals and each of the users designates his or her singing attribute for a song selected over a network at different times and in different spaces and transmits voice and video data according to singing to the server, the server generates and provides complete choral song content including a solo part and a chorus part of each of the plurality of users by matching the MIDI music with the voice data and the video data of each user according to the singing attribute designated by each of the plurality of users, and a new user participates in the content over the network to generate another version of the choral song content, thereby enabling the plurality of users to participate and generate complete choral song content.

### BACKGROUND OF THE INVENTION

### Field of the Invention

The present invention relates to a multiparty participatory MIDI-based content generation system and method configured such that a plurality of users is connected to a server via respective user terminals and transmit voice data of user's singing a song based on MIDI music and video data of a user's singing appearance to the server and such that the server generates and provides MIDI-based content in which the plurality of users participates using the data received from the user terminals.

### Description of the Related Art

These days, people don't just want to listen to quality music, such as MIDI music, but want to show off their singing skills while singing along with the latest trending songs.

In the past, people used to sing along with the accompaniment of a song using a song accompaniment machine installed in a karaoke bar, etc., but as the technology for personal mobile communication devices such as smartphones has improved in recent years, high-quality video and audio recording is possible on the personal mobile communication devices such as smartphones, and as the functions of social networks have expanded, people produce various kinds of content related to music with their personalities using their smartphones and publish the same through social networks.

People share videos of their daily lives, or videos of their singing or dancing appearances through the social networks, and furthermore content about singing, dancing, and the like is produced and published by friends who have made connections through the social networks.

There is a significant need for an undesignated number of users to participate in the production of a single piece of content through the social networks and to build a sense of community, but there are few such programs and little systemic support.

Particularly, in the case of singing, there is a strong desire for anyone to join, to sing in chorus, and to create a sense of unity among participants, but conventionally, choral song content is simply provided by combining recorded voices of a plurality of users to generate content as group singing rather than a chorus.

Since the meaning of each user participating in the chorus with his/her individuality is diminished in the content generated as group singing, however, it is meaningful to create a chorus generated by a plurality of users in the state in which the chorus includes parts in which each participant sings solo, parts in which some users sing their respective parts, and parts in which all users sing in chorus, but there has been no technology for the production of such complete multiparty participatory choral song content in the past.

### PRIOR ART DOCUMENTS

Korean Patent Application Publication No. 10-2014-0056522
Korean Patent Application Publication No. 10-2021-0024774
Korean Patent Application Publication No. 10-2016-0028016
Korean Patent Application Publication No. 10-2001-0082593

### SUMMARY OF THE INVENTION

It is an object of the present invention to provide a multiparty participatory MIDI-based content generation system and method configured such that that a plurality of users communicates with a server via respective user terminals and each of the users designates his or her singing attribute for a song selected over a network at different times and in different spaces and transmits voice and video data according to singing to the server, the server generates and provides complete choral song content that appropriately includes a solo part and a chorus part of each of the plurality of users by matching the MIDI music with the voice data and the video data of each user according to the singing attribute designated by each of the plurality of users, and a new user participates in the content over the network to generate another version of the choral song content, thereby enabling the plurality of users to participate and generate complete choral song content.

In accordance with an aspect of the present invention, the above and other objects can be accomplished by the provision of a multiparty participatory MIDI-based content generation method provided by a server with which a plurality of users communicates via respective user terminals, the multiparty participatory MIDI-based content generation method including dividing, by the server, a song into a plurality of parts based on lyrics of the song and designating, by a user who selects the song, a singing attribute for each of the divided parts of the song, transmitting voice data of the user who designates the singing attribute singing the song through his/her user terminal and video data of a singing appearance of the user acquired by a camera module of the user terminal to the server and combining, by the server, MIDI data of the song with the received data to generate seed content, designating, by a participant who selects the seed content, the singing attribute for each of the divided parts of the song, transmitting voice data of the participant singing the song through his/her user terminal and video data of a singing appearance of the participant to the server, and matching, by the server, the voice data and the video data for a part of the seed content in which the participant participates according to the singing attribute designated by the user and the singing attribute designated by the participant to generate MIDI-based choral song content.

The singing attribute may include a solo attribute in which a user sings solo and a chorus attribute in which a plurality of participants sings together, and the step of designating the singing attribute for each of the divided parts may include designating any one of the solo attribute and the chorus attribute for each of the divided parts.

The step of generating the choral song content may include matching, for a part for which the solo attribute is designated, among the plurality of parts of the song, a corresponding part of the voice data of the user or the participant who designates the solo attribute with MIDI data for the song in each period and generating a video of the user or the participant corresponding to the voice data of the solo attribute as a single screen video in each period and combining, for a part for which the chorus attribute is designated, among the plurality of parts of the song, voice data of participants, among the plurality of users, to match the part to the MIDI data for the song and generating videos of the participants as split-screen videos, and for the parts of the song for which the solo attribute is designated, a voice and a video of each of the users designating the attribute are output, and for the parts of the song for which the chorus attribute is designated, the voice data of the users designating the attribute are combined to generate content in which voices of the users singing together and videos of the users singing together are output as split-screen videos.

The singing attribute may include a solo attribute in which a user sings solo, a solo locked attribute in which the solo attribute is locked such that only a user who designates the solo attribute can sing solo, and a chorus attribute in which a plurality of participants sings together, the step of designating, by the user, the singing attribute for each of the divided parts of the song may include selectively designating, by the user, at least one of the solo attribute, the solo locked attribute, and the chorus attribute for each of the divided parts of the song through his/her user terminal and storing the same in the server as designated singing attribute information of the user, and the step of designating, by the participant, the singing attribute for each of the divided parts of the song may include selectively designating, by the participant, at least one of the solo attribute, the solo locked attribute, and the chorus attribute for each of the parts for which the user designates the solo attribute and the chorus attribute through his/her user terminal and storing the same in the server as designated singing attribute information of the participant.

The step of generating the choral song content may include replacing the voice data of the user corresponding to a period of the part for which the solo attribute or the solo locked attribute is designated by the participant, among the user's solo attribute parts of the seed content, by extracted voice data of the participant in the period and replacing the video data of the user in the period by extracted video data of the participant to display a single screen video and extracting voice data of the participant corresponding to a period of the part for which the chorus attribute is designated and combining the same with the voice data of the user in the period to generate a chorus voice and generating video data of the user and the video data of the participant corresponding to the period of the part for which the chorus attribute is designated as split-screen videos to generate the choral song content.

The generated choral song content may be selected by a new participant to enable a new version of the choral song content involving the new participant to be generated through designating of a new singing attribute and matching of voice data and video data of the new participant accordingly.

The multiparty participatory MIDI-based content generation method may further include designating and setting, by an n-th user, at least one of the solo attribute, the solo locked attribute, and the chorus attribute for the plurality of divided parts of the song, transmitting voice data of n-th user's singing along with MIDI music for the song and video data of an n-th user's singing appearance to the server, and extracting voice data of the n-th user corresponding to a period of the part for which the solo attribute or the solo locked attribute is designated by the n-th user, among the previous user's solo attribute parts of the choral song content, to replace the voice data of the previous user, extracting video data of the n-th user in the period as a single screen video to replace the video data of the previous user, extracting voice data of the n-th user corresponding to a period of the part for which the chorus attribute is designated and combining the same with the voice data of the previous users in the period to generate a chorus voice, and generating the video data of the previous users and the video data of the n-th user corresponding to the period of the part for which the chorus attribute is designated as split-screen videos to generate another version of the choral song content.

In accordance with another aspect of the present invention, there is provided a multiparty participatory MIDI-based content generation method provided by a server with which a plurality of users communicates via respective user terminals, the multiparty participatory MIDI-based content generation method including designating and setting a singing attribute desired by a first user for each of a plurality of parts divided based on lyrics of a song selected in a user terminal of the first user, playing MIDI music according to MIDI data of the selected song on the user terminal of the first user and transmitting voice data of the first user singing video data of a singing appearance of the first user acquired by a camera module of the user terminal of the first user to the server, generating, by the server, first content, which is a combination of MIDI music for the selected song and a voice and a video of the first user or which is content combined with previously generated content, using the data received from the user terminal of the first user according to the singing attribute designated by the first user, designating and setting a singing attribute desired by a second user for each of the plurality of parts of the song of the first content in a user terminal of the second user, playing MIDI music according to MIDI data of the song of the first content on the user terminal of the second user and transmitting voice data of the second user singing video data of a singing appearance of the second user acquired by a camera module of the user terminal of the second user to the server, and combining, by the server, the data received from the user terminal of the second user with the first content according to the singing attribute designated by the second user to generate second content, which is content of a choral song by collaboration among the plurality of users comprising the first user and the second user.

The singing attribute may include a solo attribute in which a user sings solo, a solo locked attribute in which the solo attribute is locked such that only a user who designates the solo attribute can sing solo, and a chorus attribute in which a plurality of participants sings together, the step of generating the first content may include extracting voice data of the first user corresponding to a period of a part for which the solo attribute, the solo locked attribute, or the chorus attribute is designated according to the singing attribute designated by the first user, matching the same to the MIDI data, extracting video data of the first user in the period, and generating the same as a single screen video to generate the first content, and the step of generating the second content may include replacing voice data of the first user corresponding to a period of the part for which the solo attribute or the solo locked attribute is designated by the second user, among the first user's solo attribute parts of the first content, by extracted voice data of the second user in the period, replacing the video data of the first user in the period by extracted video data of the second user to display a single screen video, extracting voice data of the second user corresponding to a period of the part for which the chorus attribute is designated and combining the same with the voice data of the first user in the period to generate a chorus voice, and generating video data of the first user and the video data of the second user corresponding to the period of the part for which the chorus attribute is designated as split-screen videos to generate the second content.

The multiparty participatory MIDI-based content generation method may further include designating and setting a singing attribute desired by a third user, among a solo attribute in which a user sings solo, a solo locked attribute in which the solo attribute is locked such that only a user who designates the solo attribute can sing solo, and a chorus attribute in which a plurality of participants sings together, for each of the plurality of parts of the song of the second content in a user terminal of the third user, transmitting voice data of third user's singing along with MIDI music for the song and video data of a third user's singing appearance to the server, and extracting voice data of the third user corresponding to a period of the part for which the solo attribute or the solo locked attribute is designated by the third user, among the previous user's solo attribute parts of the second content, to replace the voice data of the previous user, extracting video data of the third user in the period as a single screen video to replace the video data of the previous user, extracting voice data of the third user corresponding to a period of the part for which the chorus attribute is designated and combining the same with the voice data of the previous users in the period to generate a chorus voice, and generating the video data of the previous users and the video data of the third user corresponding to the period of the part for which the chorus attribute is designated as split-screen videos to generate third content, which is another choral song.

In accordance with a further aspect of the present invention, there is provided a multiparty participatory MIDI-based content generation system provided by a server with which a plurality of users communicates via respective user terminals, wherein each of the user terminals includes a display and a camera module, the user terminal being configured to play MIDI music according to MIDI data, to collect voice data according to user's singing, to divide a song selected from a plurality of songs into a plurality of parts based on lyrics such that a user designates a singing attribute for each of the divided parts, to collect voice data according to user's singing and video data of a user's singing appearance acquired by the camera module while the MIDI music of the song is played, and to transmit the collected data to the server, and the server is configured to generated first content, which is a combination of MIDI music for the song and a voice and a video of the user or which is content combined with previously generated content, using the voice data and the video data received from the user terminal of the user according to the singing attribute designated by the user for each of the divided parts of the song and to combine voice data and video data received from a user terminal of a next user with the first content according to a singing attribute designated by the next user for each of the divided parts of the song to generate second content, which is content of a choral song by collaboration among the plurality of users comprising the user and the next user.

The singing attribute may include a solo attribute in which a user sings solo, a solo locked attribute in which the solo attribute is locked such that only a user who designates the solo attribute can sing solo, and a chorus attribute in which a plurality of participants sings together, the server may extract voice data of the user corresponding to a period of a part for which the solo attribute, the solo locked attribute, or the chorus attribute is designated according to the singing attribute designated by the user, may match the same to the MIDI data, may extract video data of the user in the period, and may generate the same as a single screen video to generate the first content, and the server may replace voice data of the user corresponding to a period of the part for which the solo attribute or the solo locked attribute is designated by the next user, among the user's solo attribute parts of the first content, by extracted voice data of the next user in the period, may replace the video data of the user in the period by extracted video data of the next user to display a single screen video, may extract voice data of the next user corresponding to a period of the part for which the chorus attribute is designated and combining the same with the voice data of the user in the period to generate a chorus voice, and may generate video data of the user and the video data of the next user corresponding to the period of the part for which the chorus attribute is designated as split-screen videos to generate the second content.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a multiparty participatory MIDI-based content generation system according to an embodiment of the present invention;

FIG. 2 is a flowchart showing a content generation method by the multiparty participatory MIDI-based content generation system according to the embodiment of the present invention having the configuration shown in FIG. 1;

FIG. 3 shows a display screen of the user terminal for a selected song displaying a plurality of parts divided based on the lyrics of the selected song and a singing attribute designated for each part according to an embodiment of the present invention.

FIG. 4 shows that voice data and video data are collected as the user sings along with MIDI music of a selected song after designating singing attribute for each of the plurality of divided parts of the selected song according to an embodiment of the present invention.

FIG. 5 shows that a second user re-designate a singing attribute designated by the previous user as shown in FIG. 4C.

FIG. 6 shows the progress of a choral song content generated by a plurality of users including the first user and the second user according to the part type as shown in FIGS. 4 and 5.

FIG. 7 shows an example of a split-screen video that can be displayed in the chorus part each time a new user participates.

FIG. 8 shows the case in which user A and user B participate to generate choral song content according to an embodiment of the present invention.

FIG. 9 also shows the case in which user A and user B participate to generate choral song content shown in FIG. 8C.

FIG. 10 shows the case in which new choral song content is generated as the result of the participation of user C as another user in the choral song content in which user A and user B participated as shown in FIG. 9.

FIG. 11 also shows the case in which user A, user B, and user C participate to generate another version of the choral song content shown in FIG. 10C.

### DETAILED DESCRIPTION OF THE INVENTION

Hereinafter, a multiparty participatory MIDI-based content generation system and method according to the present invention will be described in detail with reference to embodiments shown in the drawings.

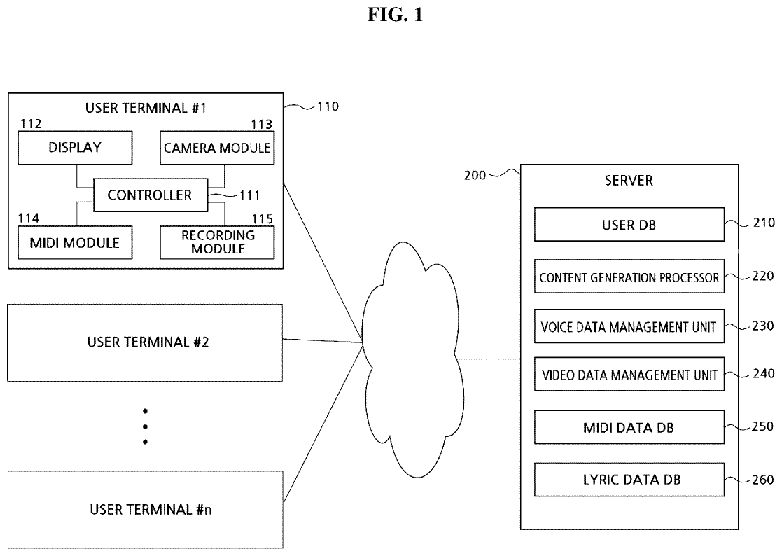

First, a multiparty participatory MIDI-based content generation system according to an embodiment of the present invention will be described with reference to FIG. 1. FIG. 1 is a block diagram showing the configuration of a multiparty participatory MIDI-based content generation system according to an embodiment of the present invention.

As shown in FIG. 1, the multiparty participatory MIDI-based content generation system according to the embodiment of the present invention is a system in which user terminals #1, #2 . . . #n of a plurality of users and a server 200 form a network while communicating with each other, and basically has a configuration in which data collected by the user terminals and transmitted to the server 200 is processed by the server 200 to generate predetermined content.

The multiparty participatory MIDI-based content generation system according to the embodiment of the present invention is a system for generating choral song content by collaborative participation among a plurality of users, which is completely different from a conventional method in which a plurality of users participating in the generation of a choral song transmit all relevant data such as their voices to a server and the server generates the choral song using all of the relevant data.

That is, the multiparty participatory MIDI-based content generation system according to the embodiment of the present invention is a system for generating multiparty participatory choral song content in which a first user transmits voice and video data of his/her singing based on MIDI music for a specific song to a server, and the server uses the data to generate seed content, and whenever a new user participates, the data of the new participant's singing is added, and new content is continuously generated.

In this case, the multiparty participatory MIDI-based content generation system according to the embodiment of the present invention is configured to generate complete choral song content each time a user participates in the content generation by dividing the original song required for content generation into a plurality of parts based on lyrics and designating a singing attribute for each of the plurality of divided parts for each user participating in the content generation, and matching necessary parts of new participant's data to pre-generated content according to the singing attribute to generate the complete choral song content, rather than simply combining new participant's data with the pre-generated content.

In the multiparty participatory MIDI-based content generation system according to the embodiment of the present invention, a user terminal 110 carried by each of a plurality of users may include a display 112 configured to display a list of songs and the like on a screen, a camera module 113 configured to take a video of a user's singing appearance, a MIDI module 114 configured to implement a software synthesizer and to provide MIDI music by MIDI data based on sound fonts, a recording module 115 configured to record a user's voice, and a controller 111 configured to control the above components and to perform control such that collected data is transmitted to the server.

Although not shown in the figure, the user terminal may basically include a speaker configured to output music and a communication module configured to communicate with the server.

The user terminal 110 is connected to a network, such as the Internet, in order to communicate with the server 200, and when the user terminal 110 receives and displays a list of selectable songs for content production from the server 200, the user may select a desired song from the list of songs, and for the song selected by the user, the song is divided into a plurality of parts based on the lyrics of the song and displayed, and the user may designate a singing attribute for each of the plurality of divided parts of the song and transmit the same to the server.

The user may sing along with the MIDI music of the song implemented by the MIDI module 114 of the user terminal 110, and the recording module 115 may collect voice data of the user's singing, and the camera module 113 may take a video of the user's singing appearance to collect video data according to the singing and transmit the same to the server.

The server 200 may comprise a user DB 210, a content generation processor 220, a voice data management unit 230, a video data management unit 240, a MIDI data DB 250, and a lyric data DB 260, as shown in FIG. 1.

The user DB 210 stores information about users of user terminals connected to the server 200, and when a user terminal of a single user is connected to the server, the server may recognize the user of the user terminal by receiving information about the user from the user terminal and checking the same in the user DB 210.

The voice data management part 230 stores the voice data of the user transmitted from the user terminal and manages period-specific voice data of each of the plurality of divided parts for the selected song.

The video data management part 240 stores the video data of the user transmitted from the user terminal and manages period-specific video data of each of the plurality of divided parts for the selected song.

The MIDI data DB 250 stores and manages MIDI data for each of selectable songs for content production.

The lyric data DB 260 stores and manages lyric information for each of selectable songs for content production and lyric information corresponding to each of the plurality of divided parts of each song.

When relevant data for content production is transmitted from the user terminal to the server 200, the voice data of the user is managed by the voice data management unit 230, the video data of the user is managed by the video data management unit 240, and the content generation processor 220 may check the singing attribute designated by the user are checked, may extract the voice data and video data corresponding to the period where the voice and the video of the user are matched according to the singing attribute, and may generate MIDI-based content using the same.

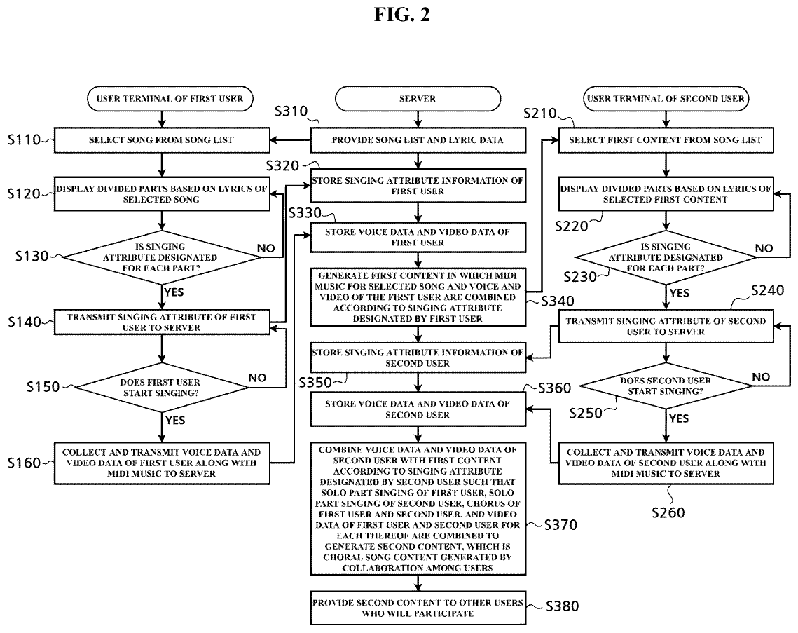

A content generation method by the multiparty participatory MIDI-based content generation system according to the embodiment of the present invention having the configuration as described above will be described with reference to a flowchart shown in FIG. 2.

FIG. 2 shows a process in which first content is generated by a first user and then data by a second user is added to the first content to generate second content using the multiparty participatory MIDI-based content generation system according to the embodiment of the present invention.

First, the server may provide a list of selectable songs and lyric data for each song to a user terminal of the first user (S310), and the first user may select a song from the list of selectable songs provided by the server on his or her user terminal (S110).

The user terminal of the first user may display a plurality of divided parts based on the lyrics of the selected song (S120), and the first user may designate his or her singing attribute for each of the plurality of divided parts (S130).

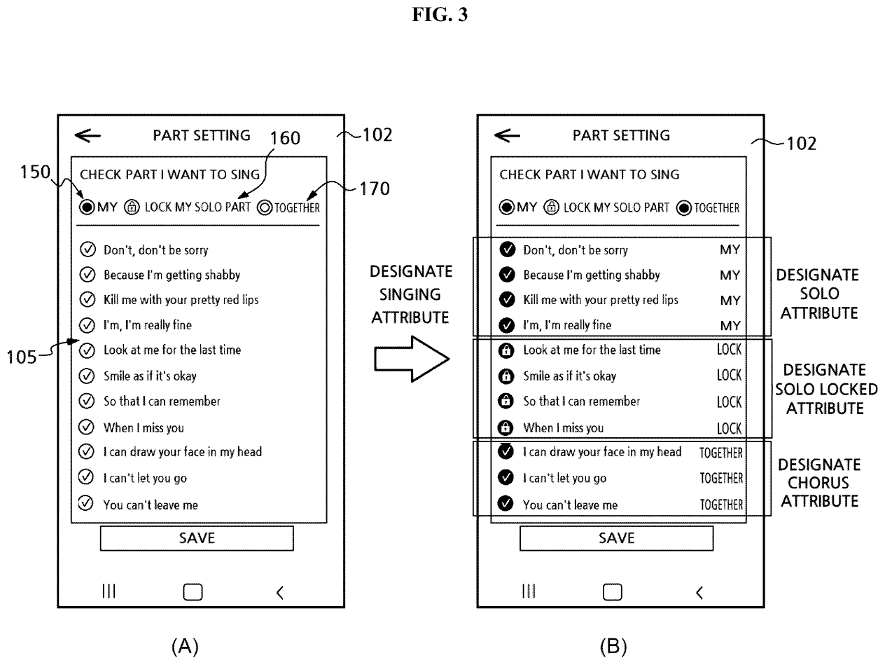

In this regard, referring to FIG. 3, FIG. 3A shows the state in which a display screen 102 of the user terminal for the song selected by the user displays the plurality of parts 105 divided based on the lyrics of the song, and FIG. 3B shows the state in which a singing attribute is designated for each part in the state shown in FIG. 3A.

As shown in FIG. 3A, in the plurality of divided parts 105 for the selected song, a lyric part corresponding to one verse of the overall lyrics for the song may be set to one part.

The division of a song into a plurality of parts is preset by the server, the parts are separated from each other in detail based on the period of each divided part, e.g., sound data of the MIDI notes, and the period information of each part, i.e., information about the starting position and the ending position of each part, is preset by the server.

The user may designate a preset singing attribute for each of the plurality of divided parts of the song. As shown in FIG. 3A, the singing attribute may include a solo attribute 150 in which the user sings solo, a solo locked attribute 160 in which the solo attribute is locked such that only the designated user can sing solo the part, and a chorus attribute 170 in which a plurality of participants sings together.

In of FIGS. 3A and 3B, the “MY” labeling for solo attribute 150 is meant to indicate that the user sings solo, the solo locked attribute 160 is labeled “LOCK MY SOLO PART”, and the chorus attribute 170 is labeled “TOGETHER”.

The user may select desired singing attributes 150, 160, and 170 and may designate parts having the attributes. For example, as shown in FIG. 3B, the solo attribute 150 may be designated for the first four parts, the solo locked attribute 160 may be designated for the next five parts, and the chorus attribute 170 may be designated for and the next three parts.

As described above, the information about the designated singing attributes is stored in the server as the singing attribute information of the user having the user terminal and is used as a reference for editing data when producing future content.

Although FIG. 3 illustrates that three singing attributes are designated by the user: a solo attribute, a solo locked attribute, and a chorus attribute, the present invention is not limited thereto, and two attributes may be designated or four or more attributes may be designated.

For example, the solo attribute and the chorus attribute may be set as the singing attributes without the solo locked attribute, or four or more attributes, such as a solo attribute, a solo locked attribute, a chorus attribute, and a chorus locked attribute, may be set as the singing attributes (where “chorus locked attribute” means locking the chorus attribute such that no other users can change the chorus attribute).

The content generation system and method according to the present invention is basically configured such that a plurality of users participates one by one to generate new content one by one in sequence, wherein, in view of the fact that a simple chorus song in which the voices of the plurality of users are combined is not generated but a complete chorus song that appropriately includes a solo part and a chorus part that is sung together so as to utilize the individuality of each user is generated, the singing attributes are designated as described above, only the necessary parts of the voice and the image of each participant can be appropriately extracted and matched according to the designated singing attributes, and it can be determined whether two, three, or four attributes are to be set as the singing attributes in order to achieve the result.

If two attributes, such as a solo attribute and a chorus attribute, are set as the singing attributes, after seed content is generated by the first user, the previously designated singing attributes may be completely changed so as to be suitable for the user whenever the next user is added, and in a worst case, a greedy user may change all the singing attributes to his/her solo part; however, this may be the best way to show the user's personality because each user can freely designate the singing attributes that are suitable for him/her to generate content.

If four attributes, such as a solo attribute, a solo locked attribute, a chorus attribute, and a chorus locked attribute, are set as the singing attributes, the next user added after the first user may not have many parts for which singing attributes can be designated, whereby many users cannot participate in content generation, but this is a way to ensure that the contributions of the participants are guaranteed.

Which singing attributes are to be included and designated may be changed depending on the nature and characteristics of the choral content that is generated by the user.

Referring back to FIG. 2, once the singing attribute by the first user is designated for each of the plurality of divided parts for the song selected using the method described above, the designated singing attribute may be transmitted to the server (S140) and may be stored in the server as the singing attribute of the first user (S320).

After the singing attribute is designated as described above, the first user may start singing the song along with the MIDI music of the song using the functions of the MIDI module, the recording module, and the camera module of the user terminal (S150), the user terminal may collect and transmit the voice data of the first user singing the song along with the MIDI music and the video data of the user's singing appearance to the server (S160), and the server may receive and store the same as the voice data and the video data of the first user (S330).

Subsequently, the server may generate first content in which the MIDI music for the song and the voice and the video of the first user are combined according to the singing attribute designated by the first user (S340).

If the first content described above is the first content generated by the first user, the content contains only the voice and the video of the first user, and the content is referred to as “seed content” because the content is a seed for new content that will be generated by other users in the future.

Since the multiparty participatory MIDI-based content generated by the system and method according to the embodiment of the present invention is new multiparty participatory content generated by each subsequent user based on initial seed content, the first content may be a combination of the seed content and the first user's voice and video according to his or her designated singing attribute.

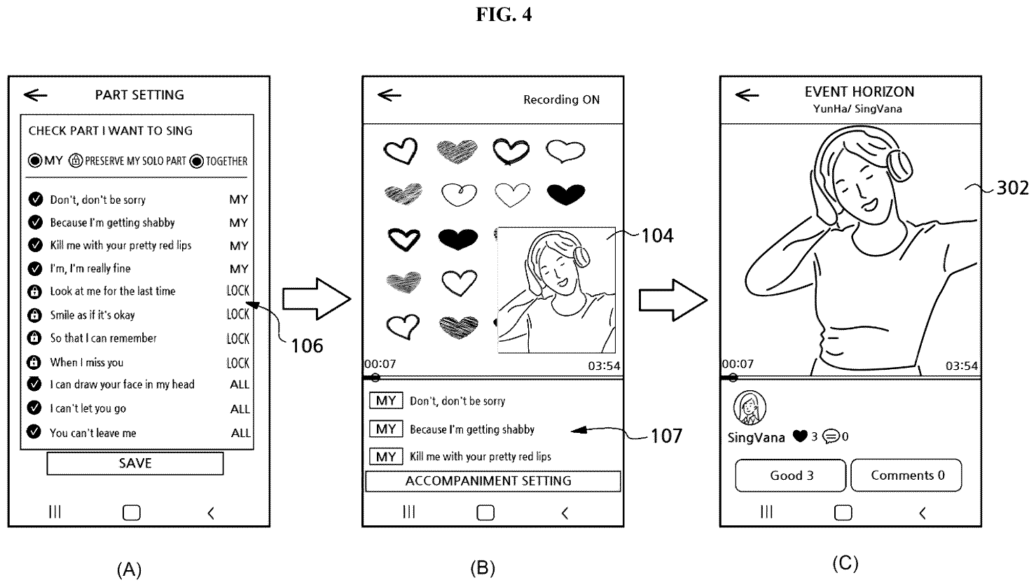

FIG. 4 shows that voice data and video data are collected as the user sings along with the MIDI music of the selected song after designating the singing attribute for each of the plurality of divided parts of the selected song (see FIG. 3), and the voice data and the video data are transmitted to the server to generate and execute the first content.

FIGS. 4A to 4C show screens of the user terminal, wherein FIG. 4A shows a screen 106 in which the user designates the singing attribute for each of the plurality of divided parts of the selected song, as shown in FIG. 3B, FIG. 4B shows that the user terminal collects voice data and video data as the user sings along with the MIDI music of the selected song, and FIG. 4C shows that the first content generated by the server is executed on the user terminal.

When the user sings the selected song through the user terminal, the user terminal drives the MIDI module to play the MIDI music for the selected song while operating the camera module and the recording module to collect voice data of the user, and at the same time, the camera module takes a video of the a user's singing appearance to collect video data of the user. When the user sings, as shown in FIG. 4B, the screen of the user terminal viewed by the user displays a video 104 of the a user's singing appearance such that the user can see his or her appearance, and the screen also displays a song part display 107 indicating the part of the song in progress such that the user can check the part that the user is currently singing.

In addition, the song part display 107 may display which singing attribute is designated for each of the displayed parts.

The collected voice data of the user's singing and the video data of the user's singing appearance may be transmitted to the server, and the server may generate the first content in which the MIDI music, the user's voice, and the user's video for the song are combined according to the singing attribute designated by the user, may load the song in the song list, and may provide the same to users connected thereto.

The generated first content may be executed on the user terminal, and may display a full-screen video 302 of the user singing while outputting the voice of the user singing along with the MIDI music, as shown in FIG. 4C.

Referring back to FIG. 2, the server may generate the first content using the data of the first user's singing as described above, may load the first content in the song list, and may provide the same to the users connected thereto, wherein the second user may select the first content from the song list (S210).

The user terminal of the second user may display a plurality of divided parts based on lyrics of the selected first content song (S220), and the second user may designate his or her singing attribute for each of the plurality of divided parts (S230).

In this case, the second user may designate new singing attributes for the parts that can be changed among the parts having singing attributes previously designated by the first user, and the second user cannot designate new singing attributes for the parts for which the singing attribute set to “lock” by the previous user, the first user, such as “solo locked attribute,” are designated. This is because the parts previously designated as “solo locked attribute” by the first user are set to be fixed as the parts that the first user sings solo and cannot be changed arbitrarily by subsequent users. Of course, the second user may newly designate the solo locked attribute for the parts for which singing attributes can be designated such that the parts can be locked as his/her solo parts.

When the singing attribute of the second user is designated for each of the plurality of divided parts for the song selected using the method described above, the designated singing attribute may be transmitted to the server (S240), and may be stored in the server as the singing attribute of the second user (S350).

After designating the singing attribute as described above, the second user may start singing the song along with the MIDI music of the song using the functions of the MIDI module, the recording module, and the camera module of the user terminal (S250), the user terminal may collect and transmit the voice data of the second user singing the song along with the MIDI music and the video data of the second a user's singing appearance to the server (S260), and the server may receive and store the same as the voice data of the second user and the video data of the second user (S360).

The server may combine the voice data and the video data of the second user with the first content according to the singing attribute designated by the second user (matching the voice data and the video data for each period corresponding to the solo part and the chorus part of the second user) such that the solo part singing of the first user, the solo part singing of the second user, the chorus of the first user and the second user, and the video data of the first user and the second user for each thereof are combined to generate the second content, which is the choral song content generated by the collaboration among the plurality of users (S370).

FIG. 2 shows a process leading to the generation of second content, which is the result of the participation of the first user and the second user; however, a third user, a fourth user . . . an n-th user may participate respectively to generate third content, fourth content . . . n-th content in the same manner.

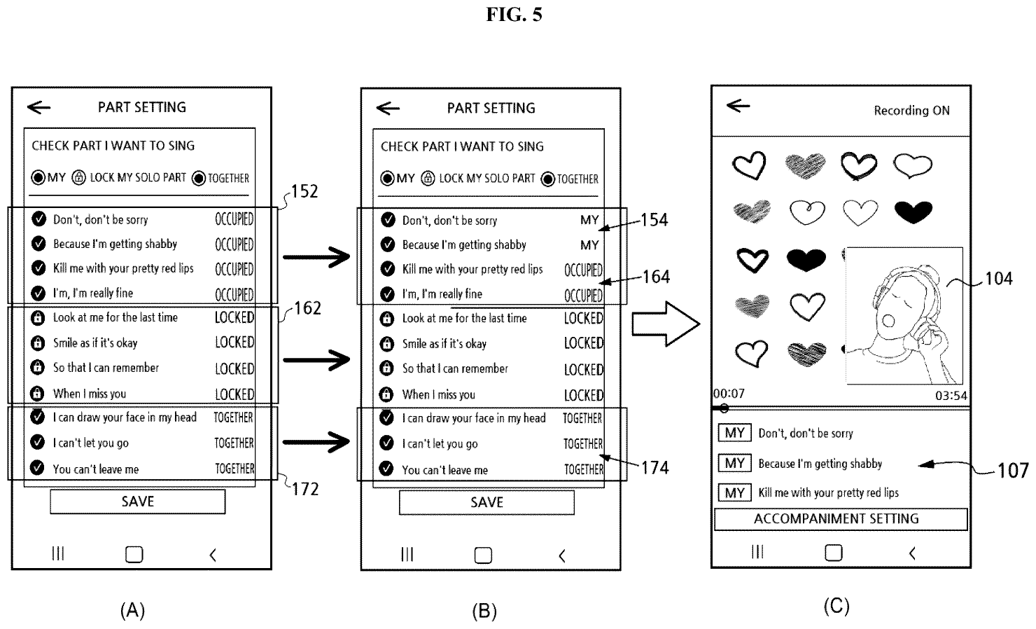

In this regard, referring to FIG. 5, FIG. 5A shows the state in which the first content song is divided into a plurality of parts based on the lyrics of the song and a singing attribute is designated for each part by the previous user.

FIG. 5A shows an example in which the solo attribute is designated (152) for the first four parts by the previous user, the solo locked attribute is designated (162) for the next five parts by the previous user, and the chorus attribute is designated (172) for the next three parts by the previous user, which is the same as the previous user designating the singing attributes as shown in FIGS. 3B and 4A.

The second user may re-designate his or her singing attribute for the remainder of the parts for which the previous user designated the singing attribute excluding the parts for which the locked attribute, i.e., the “solo locked attribute,” was designated, as shown in FIG. 5A. The parts for which the second user newly designated the singing attribute are shown in FIG. 5B.

FIG. 5B shows an example in which, for the parts 152 for which the solo attribute was designated by the previous user, the second user designates (154) his/her solo attribute for first two parts and designates (164) his/her solo locked attribute for the next two parts, the parts 162 locked as his/her solo parts, for which the previous user designated the solo locked attribute, was maintained because the parts could not be changed by the second user, and the second user also designated the chorus attribute (174) for the parts 172 for which the previous user designated the chorus attribute.

After the designation of the newly assigned or changed singing attribute by the second user, who is the current user, from the singing attribute assigned by the previous user is completed, a video 104 of the a user's singing appearance may be displayed on the screen of the user terminal that the user is viewing when the user is singing such that the user can check his/her singing appearance, a song part display 107 indicating the part of the song in progress is also displayed on the screen to allow the user to see which part the user is currently singing, and the song part display 107 may display which singing attribute is designated for the displayed part, as shown in FIG. 5C.

The collected voice data of the user's singing and the collected video data of the user's singing appearance may be transmitted to the server, and the server may generate a new choral song, the second content, by matching the second user's voice and video to the previously generated first content (seed content or choral song content) according to the singing attributes designated by the second user. In this way, N pieces of content may be generated.

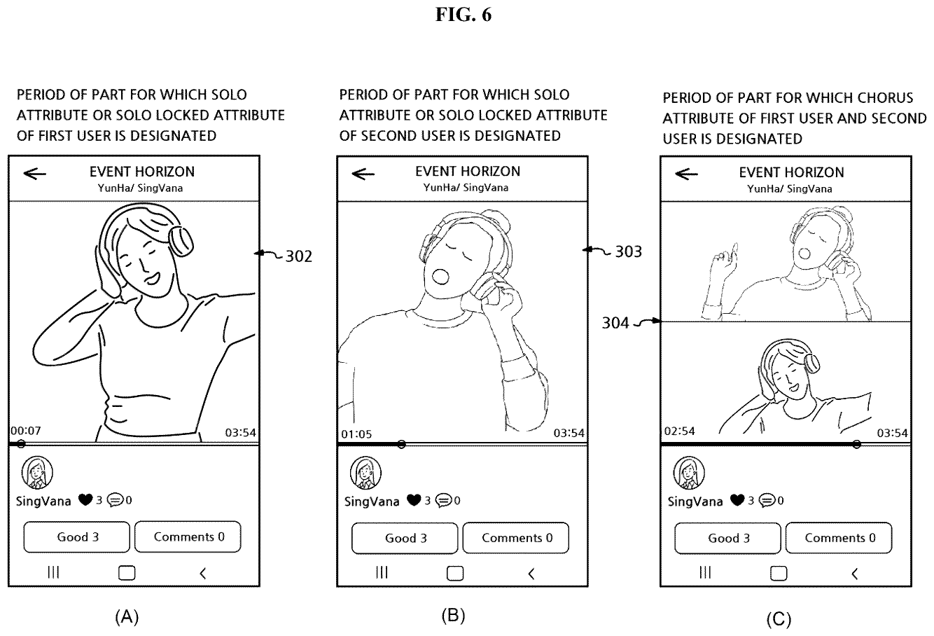

The second content generated at this time may be executed on the user terminal, and FIGS. 6A to 6C show the progress of the choral song content generated by the plurality of users including the first user and the second user according to the part type as described above.

FIG. 6A shows a scene in which a period of the second content corresponding to the parts for which the first user designated the solo attribute or the solo locked attribute is executed, wherein the voice of the first user's solo part is output along with the MIDI music, and at the same time, the video of the first user's singing appearance is displayed and played as a full-screen video 302.

FIG. 6B shows a scene in which a period of the second content corresponding to the parts for which the second user designated the solo attribute or the solo locked attribute is executed, wherein the voice of the second user's solo part is output along with the MIDI music, and at the same time, the video of the second user's singing appearance is displayed and played as a full-screen video 303.

FIG. 6C shows a scene in which a period of the second content corresponding to the parts for which the first user and the second user designated the chorus attribute is executed, wherein the voices of the first user and the second user are output along with the MIDI music, and at the same time, the video of the first user's singing appearance and the video of the second user's singing appearance are displayed and played as split-screen videos 304 on a single screen.

As such, the choral song content in which the plurality of users participated is characterized in that, in the solo part of each user, the video of the user's singing appearance is displayed in full screen, and in the part in which the plurality of users sings together, the video of the singing appearance of each of the plurality of users is displayed as a split-screen video, such that the individuality of each of the users who participated in the production of the choral song content is revealed, and the users are directed to sing together, thereby generating highly complete content.

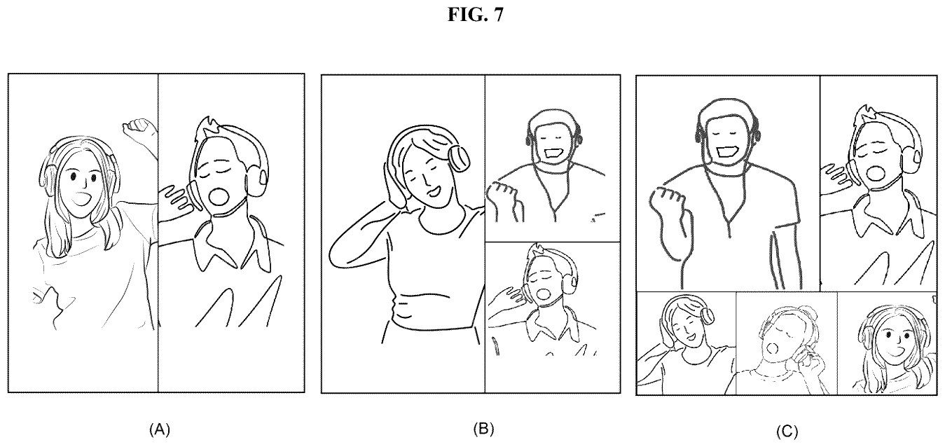

As previously described, the present invention is characterized in that not only two users but also three, four, . . . n users participate in generating new choral song content, and an example of a split-screen video that can be displayed in the chorus part each time a new user participates is shown in FIG. 7.

FIG. 7A shows an example of split-screen videos displaying singing appearances of two users in a chorus part of content in which the two users participate, FIG. 7B shows an example of split-screen videos displaying singing appearances of three users in a chorus part of content in which the three users participate, and FIG. 7C shows an example of split-screen videos displaying singing appearances of five users in a chorus part of content in which the five users participate.

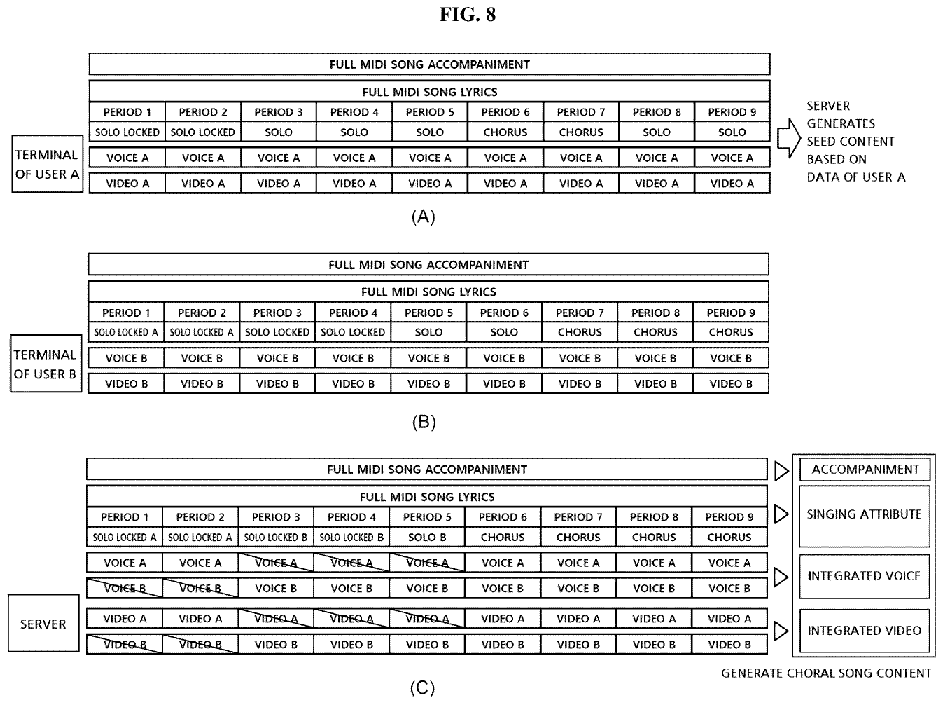

Hereinafter, a mechanism by which content is produced in accordance with a multiparty participatory MIDI-based content generation method according to an embodiment of the present invention will be described with reference to FIGS. 8 to 11.

FIG. 8A shows that user A designates the singing attribute for each of the periods (period 1 to period 9) of the divided parts for the entire MIDI song lyrics using a terminal of user A, collects voice data (VOICE A) according to the singing along with the accompaniment of the entire MIDI song and video data (VIDEO A) of the singing appearance, and transmits the same to the server, and the server generate first content, i.e., seed content, using the same.

Once the seed content is generated, other users may participate in the generation of new content by selecting the content song from the song list, as shown in FIG. 8B, which shows the case in which another user, user B, participates.

As shown in FIG. 8B, user B may designate the singing attribute for each of the periods (period 1 to period 9) of the divided parts for the entire MIDI song lyrics using a terminal of user B, may collect voice data (VOICE B) according to the singing along with the accompaniment of the entire MIDI song and video data (VIDEO B) of the singing appearance, and may transmit the same to the server.

In this case, the parts of period 1 and period 2 for which the previous user, user A, designated the solo locked attribute, among the plurality of parts of the song, are locked to user A's voice, and therefore user B cannot change the singing attribute of the parts to any other singing attribute, and user B may designate a desired one of the solo attribute, the solo locked attribute, and the chorus attribute for the remaining parts. FIG. 8B shows the case in which user B designates the solo locked attribute (locked as user B's solo part) for the parts of period 3 and period 4, designates the solo attribute (which may be arbitrarily changed by other users) for the parts of period 5 and period 6, and designates the chorus attribute for the parts of period 7 to period 9.

In this way, the data transmitted from the terminal of user B may be added to the seed content to generate new content, which is shown in FIG. 8C.

As shown in FIG. 8C, the server may generate choral song content having integrated voice and video by matching the voice data and the video data of user A and the voice data and the video data of user B in a required period according to the singing attribute designated by user A and the singing attribute designated by user B.

For all songs stored in the MIDI data DB, the server stores the lyric data for each song in the lyric data DB, and for each song, divides the song into a plurality of parts based on the lyrics, separates each part in detail based on the period of each part, e.g., the sound data of MIDI notes, and presets the period information of each part, i.e., the starting position and the ending position of each part.

In the example shown in FIG. 8, period 1 to period 9 are periods that the server divided so as to correspond to the plurality of parts based on the lyrics for the song, wherein each part corresponds to a period.

As shown in FIG. 8C, since the singing attributes of user A and user B are designated for the periods (period 1 to period 9) corresponding to the parts of the whole song, the voice data of the user may be extracted and matched for each period according to the designated singing attribute to generate an integrated voice, and the video data of the user may be extracted and matched for each period to generate an integrated video.

In the example shown in FIG. 8C, since period 1 and period 2 are parts for which user A designated the solo locked attribute, user B's voice data and user B's video data for period 1 and period 2 may be removed such that only user A's voice and video are included in the content for period 1 and period 2. In addition, since period 3 and period 4 are the parts for which user B designated the solo locked attribute and period 5 is the part for which user B designated the solo attribute, user A's voice data and user A's video data for period 3 to period 5 may be removed, and user B's voice data and video data may be extracted and matched for each period such that only user B's voice and video are included in the content for period 3 to period 5. In addition, since period 6 to period 9 are the parts for which user B designated the chorus attribute, and user A's voice data and user B's voice data are combined and user A's video data and user B's video data are combined to include the voice and video of both users singing together for the periods.

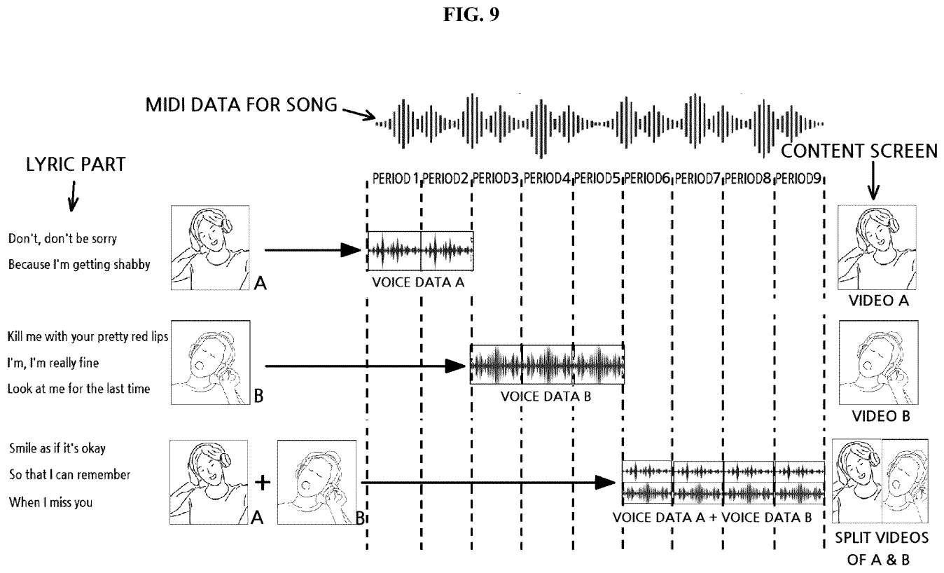

FIG. 9 also shows the case in which user A and user B participate to generate choral song content shown in FIG. 8C.

In FIG. 9, each section of the lyric part corresponds to one of periods 1 to 9, and the integrated choral song content is divided into periods (periods 1 to 9) for each part based on the lyrics for the MIDI data of the song, for periods 1 to 2, the A voice data of user A may be matched and the content screen may be configured to display the video of user A (video A) as a full-screen video, for periods 3 to 5, the B voice data of user B may be matched and the content screen may be configured to display the video of user B (video B) as a full-screen video, and for periods 6 to 9, which are the periods for which the chorus attribute is designated, the A voice data and the B voice data may be combined and matched for each period, and the content screen for each period may be configured to display video A and video B as split videos on a single screen.

In this way, choral song content in which user A and user B participated may be generated; however, the present invention is not limited thereto, the choral song content may be provided to the song list to allow another user to participate in the choral song content.

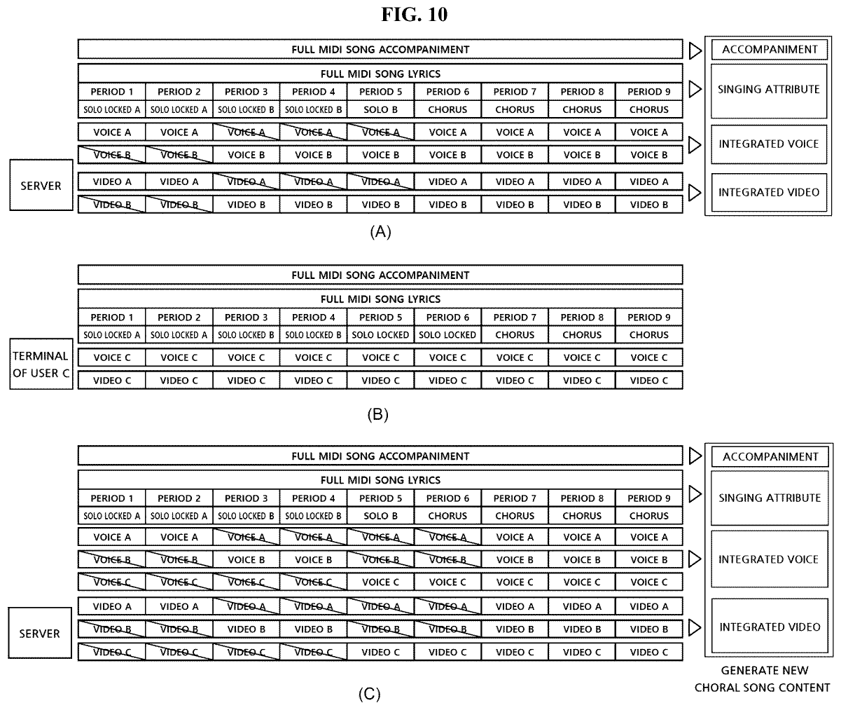

FIG. 10 shows the case in which new choral song content is generated as the result of the participation of user C as another user in the choral song content (FIG. 10A) in which user A and user B participated.

As shown in FIG. 10A, the choral song content in which user A and user B participated may be provided in the song list, and user C may select the same, may collect various kinds of data according to his/her singing, and may transmit the same to the server.

That is, as shown in FIG. 10B, user C may designate the singing attribute according to his/her singing for each of the periods (period 1 to period 9) of the parts of the song through a terminal of user C. In this case, the singing attributes of user C may be newly designated for only changeable ones of the parts for which the singing attribute was designated by the previous users, user A and user B.

As shown in FIG. 10B, since User A's solo locked attribute is designated for periods 1 and 2 and User B's solo locked attribute is designated for periods 3 and 4, user C may designate her/her singing attribute for the remaining periods, i.e., periods 5 to 9. FIG. 10B shows an example in which user C designates the solo locked attribute of user C for periods 5 and 6 and designates the chorus attribute for periods 7 to 9.

After designating the singing attribute of user C in this way, user C may collect and transmit the voice data and the video data of user C for the entire song periods to the server using a terminal of user C, or the voice data and the video data of user C may be generated for only the necessary periods (e.g., periods 5 through 9) according to his/her singing attribute (user C may record a voice and take a video for only the periods).

In response thereto, as shown in FIG. 10C, the server may generate an integrated voice by extracting the voice data of the user in each period and matching the same to the period according to the singing attribute designated by the user C and the singing attributes designated by the previous users as described above, and may generate an integrated video by extracting the video data of the user in each period and matching the same to the period accordingly.

In the example shown in FIG. 10C, since period 1 and period 2 are parts for which user A designated the solo locked attribute, user C's voice data and user C's video data for period 1 and period 2 may be removed such that only user A's voice and video are included in the content for period 1 and period 2. Since period 3 and period 4 are parts for which user B designated the solo locked attribute, user C's voice data and user C's video data for period 3 and period 4 may be removed such that only user B's voice and video are included in the content for period 3 and period 4.

Since period 5 and period 6 are parts for which user C designated his/her solo locked attribute, user C's voice data and video data for period 5 and period 6 may be extracted and matched for each period such that only user C's voice and video are included in the content for period 5 and period 6.

In addition, since periods 7 to 9 are parts for which user C designated the chorus attribute, the A voice data, the B voice data, and the C voice data may be combined for the periods and user A's video data, user B's video data, and user C's video data may be combined for the periods to include the voices and videos of the three users singing together.

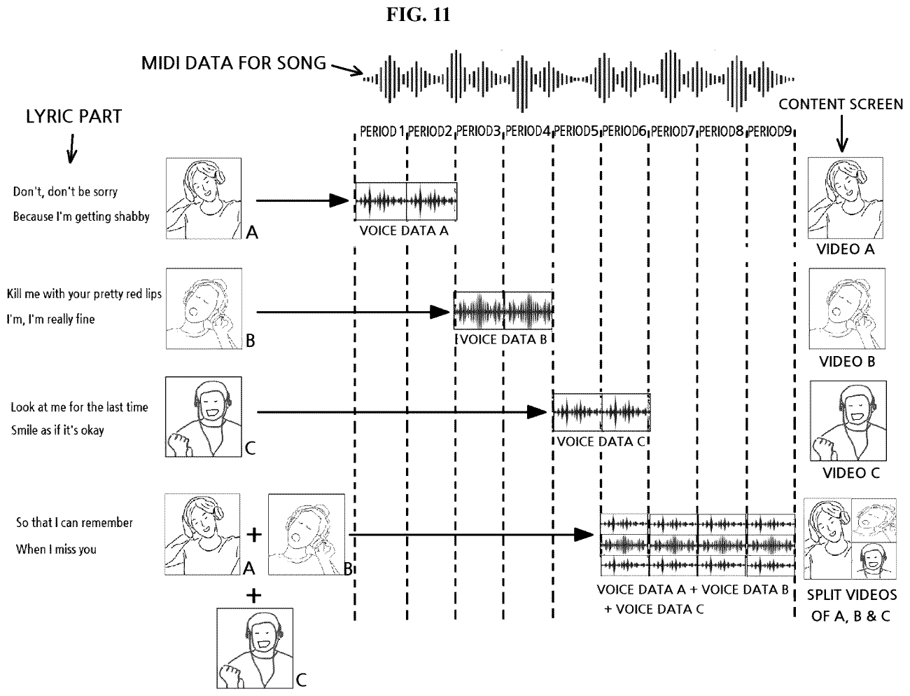

FIG. 11 also shows the case in which user A, user B, and user C participate to generate another version of the choral song content shown in FIG. 10C.

In FIG. 11, each section of the lyric part corresponds to one of periods 1 to 9, and the integrated choral song content is divided into periods (periods 1 to 9) for each part based on the lyrics for the MIDI data of the song.

For periods 1 to 2, the A voice data of user A may be matched and the content screen may be configured to display the video of user A (video A) as a full-screen video, for periods 3 and 4, the B voice data of user B may be matched and the content screen may be configured to display the video of user B (video B) as a full-screen video, for periods 5 and 6, the C voice data of user C may be matched and the content screen may be configured to display the video of user C (C video) as a full-screen video, and for periods 7 to 9, which are the periods for which the chorus attribute is designated, the A voice data, the B voice data, and the C voice data may be combined and matched for each period, and the content screen for each period may be configured to display video A, video B, and C video as split videos on a single screen.

In this way, new choral song content in which user A, user B, and user C participate may be generated. This new choral song may be provided to other users such that the other users can further participate to generate other new versions of the choral song content.

As described above, the multiparty participatory MIDI-based content generation system and method according to the present invention are characterized in that a plurality of users communicates with a server via respective user terminals and each of the users designates his or her singing attribute for a song selected over a network at different times and in different spaces and transmits voice and video data according to singing to the server, the server generates and provides complete choral song content that appropriately includes a solo part and a chorus part of each of the plurality of users by matching the MIDI music with the voice data and the video data of each user according to the singing attribute designated by each of the plurality of users, and a new user participates in the content over the network to generate another version of the choral song content, thereby enabling the plurality of users to participate and generate complete choral song content.

As is apparent from the above description, a multiparty participatory MIDI-based content generation system and method according to the present invention have an effect in that a plurality of users communicates with a server via respective user terminals and each of the users designates his or her singing attribute for a song selected over a network at different times and in different spaces and transmits voice and video data according to singing to the server, the server generates and provides complete choral song content that appropriately includes a solo part and a chorus part of each of the plurality of users by matching the MIDI music with the voice data and the video data of each user according to the singing attribute designated by each of the plurality of users, and a new user participates in the content over the network to generate another version of the choral song content, thereby enabling the plurality of users to participate and generate complete choral song content.

Those skilled in the art to which the present invention pertains will appreciate that various modifications are possible within the scope of the basic technical ideas of the present invention as described above. In addition, it is a matter of course in the spirit of the provisions of the Patent Act that the scope of protection of the present invention should be construed on the basis of the description in the claims.

1. A multiparty participatory MIDI-based content generation method provided by a server with which a plurality of users communicates via respective user terminals, the multiparty participatory MIDI-based content generation method comprising:
dividing, by the server, a song into a plurality of parts based on lyrics of the song and designating, by a user who selects the song, a singing attribute for each of the divided parts of the song;
transmitting voice data of the user who designates the singing attribute singing the song through his/her user terminal and video data of a singing appearance of the user acquired by a camera module of the user terminal to the server and combining, by the server, MIDI data of the song with the received data to generate seed content;
designating, by a participant who selects the seed content, the singing attribute for each of the divided parts of the song;
transmitting voice data of the participant singing the song through his/her user terminal and video data of a singing appearance of the participant to the server; and
matching, by the server, the voice data and the video data for a part of the seed content in which the participant participates according to the singing attribute designated by the user and the singing attribute designated by the participant to generate MIDI-based choral song content.

2. The multiparty participatory MIDI-based content generation method according to claim 1, wherein
the singing attribute comprises a solo attribute in which a user sings solo and a chorus attribute in which a plurality of participants sings together, and
the step of designating the singing attribute for each of the divided parts comprises designating any one of the solo attribute and the chorus attribute for each of the divided parts.

3. The multiparty participatory MIDI-based content generation method according to claim 2, wherein
the step of generating the choral song content comprises:
matching, for a part for which the solo attribute is designated, among the plurality of parts of the song, a corresponding part of the voice data of the user or the participant who designates the solo attribute with MIDI data for the song in each period and generating a video of the user or the participant corresponding to the voice data of the solo attribute as a single screen video in each period; and
combining, for a part for which the chorus attribute is designated, among the plurality of parts of the song, voice data of participants, among the plurality of users, to match the part to the MIDI data for the song and generating videos of the participants as split-screen videos, and
for the parts of the song for which the solo attribute is designated, a voice and a video of each of the users designating the attribute are output, and for the parts of the song for which the chorus attribute is designated, the voice data of the users designating the attribute are combined to generate content in which voices of the users singing together and videos of the users singing together are output as split-screen videos.

4. The multiparty participatory MIDI-based content generation method according to claim 1, wherein
the singing attribute comprises a solo attribute in which a user sings solo, a solo locked attribute in which the solo attribute is locked such that only a user who designates the solo attribute can sing solo, and a chorus attribute in which a plurality of participants sings together,
the step of designating, by the user, the singing attribute for each of the divided parts of the song comprises selectively designating, by the user, at least one of the solo attribute, the solo locked attribute, and the chorus attribute for each of the divided parts of the song through his/her user terminal and storing the same in the server as designated singing attribute information of the user, and
the step of designating, by the participant, the singing attribute for each of the divided parts of the song comprises selectively designating, by the participant, at least one of the solo attribute, the solo locked attribute, and the chorus attribute for each of the parts for which the user designates the solo attribute and the chorus attribute through his/her user terminal and storing the same in the server as designated singing attribute information of the participant.

5. The multiparty participatory MIDI-based content generation method according to claim 4, wherein the step of generating the choral song content comprises:
replacing the voice data of the user corresponding to a period of the part for which the solo attribute or the solo locked attribute is designated by the participant, among the user's solo attribute parts of the seed content, by extracted voice data of the participant in the period and replacing the video data of the user in the period by extracted video data of the participant to display a single screen video; and
extracting voice data of the participant corresponding to a period of the part for which the chorus attribute is designated and combining the same with the voice data of the user in the period to generate a chorus voice and generating video data of the user and the video data of the participant corresponding to the period of the part for which the chorus attribute is designated as split-screen videos to generate the choral song content.

6. The multiparty participatory MIDI-based content generation method according to claim 5, wherein the generated choral song content is selected by a new participant to enable a new version of the choral song content involving the new participant to be generated through designating of a new singing attribute and matching of voice data and video data of the new participant accordingly.

7. The multiparty participatory MIDI-based content generation method according to claim 6, further comprising:
designating and setting, by an n-th user, at least one of the solo attribute, the solo locked attribute, and the chorus attribute for the plurality of divided parts of the song;
transmitting voice data of n-th user's singing along with MIDI music for the song and video data of an n-th user's singing appearance to the server; and
extracting voice data of the n-th user corresponding to a period of the part for which the solo attribute or the solo locked attribute is designated by the n-th user, among the previous user's solo attribute parts of the choral song content, to replace the voice data of the previous user, extracting video data of the n-th user in the period as a single screen video to replace the video data of the previous user, extracting voice data of the n-th user corresponding to a period of the part for which the chorus attribute is designated and combining the same with the voice data of the previous users in the period to generate a chorus voice, and generating the video data of the previous users and the video data of the n-th user corresponding to the period of the part for which the chorus attribute is designated as split-screen videos to generate another version of the choral song content.

8. A multiparty participatory MIDI-based content generation method provided by a server with which a plurality of users communicates via respective user terminals, the multiparty participatory MIDI-based content generation method comprising:
designating and setting a singing attribute desired by a first user for each of a plurality of parts divided based on lyrics of a song selected in a user terminal of the first user;
playing MIDI music according to MIDI data of the selected song on the user terminal of the first user and transmitting voice data of the first user singing video data of a singing appearance of the first user acquired by a camera module of the user terminal of the first user to the server;
generating, by the server, first content, which is a combination of MIDI music for the selected song and a voice and a video of the first user or which is content combined with previously generated content, using the data received from the user terminal of the first user according to the singing attribute designated by the first user;
designating and setting a singing attribute desired by a second user for each of the plurality of parts of the song of the first content in a user terminal of the second user;
playing MIDI music according to MIDI data of the song of the first content on the user terminal of the second user and transmitting voice data of the second user singing video data of a singing appearance of the second user acquired by a camera module of the user terminal of the second user to the server; and
combining, by the server, the data received from the user terminal of the second user with the first content according to the singing attribute designated by the second user to generate second content, which is content of a choral song by collaboration among the plurality of users comprising the first user and the second user.

9. The multiparty participatory MIDI-based content generation method according to claim 8, wherein
the singing attribute comprises a solo attribute in which a user sings solo, a solo locked attribute in which the solo attribute is locked such that only a user who designates the solo attribute can sing solo, and a chorus attribute in which a plurality of participants sings together,
the step of generating the first content comprises extracting voice data of the first user corresponding to a period of a part for which the solo attribute, the solo locked attribute, or the chorus attribute is designated according to the singing attribute designated by the first user, matching the same to the MIDI data, extracting video data of the first user in the period, and generating the same as a single screen video to generate the first content, and
the step of generating the second content comprises replacing voice data of the first user corresponding to a period of the part for which the solo attribute or the solo locked attribute is designated by the second user, among the first user's solo attribute parts of the first content, by extracted voice data of the second user in the period, replacing the video data of the first user in the period by extracted video data of the second user to display a single screen video, extracting voice data of the second user corresponding to a period of the part for which the chorus attribute is designated and combining the same with the voice data of the first user in the period to generate a chorus voice, and generating video data of the first user and the video data of the second user corresponding to the period of the part for which the chorus attribute is designated as split-screen videos to generate the second content.

10. The multiparty participatory MIDI-based content generation method according to claim 8, further comprising:
designating and setting a singing attribute desired by a third user, among a solo attribute in which a user sings solo, a solo locked attribute in which the solo attribute is locked such that only a user who designates the solo attribute can sing solo, and a chorus attribute in which a plurality of participants sings together, for each of the plurality of parts of the song of the second content in a user terminal of the third user;
transmitting voice data of third user's singing along with MIDI music for the song and video data of a third user's singing appearance to the server; and
extracting voice data of the third user corresponding to a period of the part for which the solo attribute or the solo locked attribute is designated by the third user, among the previous user's solo attribute parts of the second content, to replace the voice data of the previous user, extracting video data of the third user in the period as a single screen video to replace the video data of the previous user, extracting voice data of the third user corresponding to a period of the part for which the chorus attribute is designated and combining the same with the voice data of the previous users in the period to generate a chorus voice, and generating the video data of the previous users and the video data of the third user corresponding to the period of the part for which the chorus attribute is designated as split-screen videos to generate third content, which is another choral song.

11. A multiparty participatory MIDI-based content generation system provided by a server with which a plurality of users communicates via respective user terminals, wherein
each of the user terminals comprises a display and a camera module, the user terminal being configured to play MIDI music according to MIDI data, to collect voice data according to user's singing, to divide a song selected from a plurality of songs into a plurality of parts based on lyrics such that a user designates a singing attribute for each of the divided parts, to collect voice data according to user's singing and video data of a user's singing appearance acquired by the camera module while the MIDI music of the song is played, and to transmit the collected data to the server, and
the server is configured to generated first content, which is a combination of MIDI music for the song and a voice and a video of the user or which is content combined with previously generated content, using the voice data and the video data received from the user terminal of the user according to the singing attribute designated by the user for each of the divided parts of the song and to combine voice data and video data received from a user terminal of a next user with the first content according to a singing attribute designated by the next user for each of the divided parts of the song to generate second content, which is content of a choral song by collaboration among the plurality of users comprising the user and the next user.

12. The multiparty participatory MIDI-based content generation system according to claim 11, wherein
the singing attribute comprises a solo attribute in which a user sings solo, a solo locked attribute in which the solo attribute is locked such that only a user who designates the solo attribute can sing solo, and a chorus attribute in which a plurality of participants sings together,
the server extracts voice data of the user corresponding to a period of a part for which the solo attribute, the solo locked attribute, or the chorus attribute is designated according to the singing attribute designated by the user, matches the same to the MIDI data, extracts video data of the user in the period, and generates the same as a single screen video to generate the first content, and
the server replaces voice data of the user corresponding to a period of the part for which the solo attribute or the solo locked attribute is designated by the next user, among the user's solo attribute parts of the first content, by extracted voice data of the next user in the period, replaces the video data of the user in the period by extracted video data of the next user to display a single screen video, extracts voice data of the next user corresponding to a period of the part for which the chorus attribute is designated and combining the same with the voice data of the user in the period to generate a chorus voice, and generates video data of the user and the video data of the next user corresponding to the period of the part for which the chorus attribute is designated as split-screen videos to generate the second content.
